(19) United States
(12) Patent Application Publication
(10) Pub. No.: US 2024/0219731 A1
(43) Pub. Date: Jul. 4, 2024

(54) POLARIZED MULTIPLEXED FIELD OF VIEW AND PUPIL EXPANSION IN A FLAT WAVEGUIDE

(71) Applicant: GOOGLE LLC, Mountain View, CA (US)

(72) Inventors: Ozan Cakmakci, San Mateo, CA (US); Kirill Afanasev, Waterloo (CA)

(21) Appl. No.: 18/557,464

(22) PCT Filed: May 19, 2022
(86) PCT No.: PCT/US2022/030002

§ 371 Date: Oct. 26, 2023

Related U.S. Application Data
(60) Provisional application No. 63/191,669, filed on May 21, 2021.

(51) Int. Cl. G02B 27/01

(52) U.S. Cl. CPC G02B 27/0172; G02B 2027/0174; G02B 2027/0178; G02B 2207/101

(57) ABSTRACT

Systems, devices, and techniques provide an increased size of an eyebox presented by a wearable display device by utilizing multiple outcouplers, each including a set of multiple holographic mirrors. Light from a micro-display is polarized via a controllable polarizer that switches between s-type and p-type polarization, collimated, passed to a TIR waveguide, and directed via multiple outcouplers to an eye of a user. The outcouplers may include one or more angular bandwidth holograms that reflect light that is incident on the hologram at a specific angle or a specific range of angles.

### BACKGROUND

The present disclosure relates generally to augmented reality (AR) eyewear, which fuses a view of the real world with a heads up display overlay. Wearable display devices, which include wearable heads-up displays (WHUDs) and head-mounted display (HMD) devices (all of which may be used interchangeably herein), are wearable electronic devices that combine real world and virtual images via one or more optical combiners, such as one or more integrated combiner lenses, to provide a virtual display that is viewable by a user when the wearable display device is worn on the head of the user. One class of optical combiner uses a waveguide (also termed a lightguide) to transfer light. In general, light from a projector of the wearable display device enters the waveguide of the optical combiner through an incoupler, propagates along the waveguide via total internal reflection (TIR), and exits the waveguide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

### BRIEF SUMMARY OF CERTAIN EMBODIMENTS

Systems, devices, and techniques are described herein that provide an increased size of an eyebox presented by a wearable display device by utilizing multiple outcouplers, each including a set of multiple holographic mirrors. Light from a micro-display is polarized via a controllable polarizer that switches between s-type and p-type polarization. The polarized light is then collimated, passed to a TIR waveguide, and directed via multiple outcouplers to an eye of a user. In certain embodiments, the outcouplers may include one or more holograms that reflect light that is incident on the hologram at a specific angle or a specific range of angles, such that the respective angular bandwidths associated with each of the holograms are non-overlapping in order to minimize crosstalk.

In certain embodiments, a wearable display device comprises a micro-display configured to project display light; a polarizer configured to receive the display light and selectively convert the display light to one of s-polarized display light or p-polarized display light; an incoupling prism configured to receive the polarized display light and transmit the polarized display light into a waveguide; and an outcoupler region of the waveguide that includes a first set of outcouplers and a second set of outcouplers, the first set of outcouplers configured to reflect s-polarized light and the second set of outcouplers configured to reflect p-polarized light.

The first set and second set of outcouplers may include one or more holographic mirrors.

At least one of the holographic mirrors may be an achromatic hologram.

The waveguide includes an eye-facing surface, such that each outcoupler of the first set of outcouplers is disposed at a first angle with the eye-facing surface, and such that each outcoupler of the second set of outcouplers is disposed at a second angle with the eye-facing surface in some embodiments.

Each outcoupler of the first set of outcouplers may be arranged as a contiguous series.

The outcouplers of the first set of outcouplers and the outcouplers of the second set of outcouplers may be arranged in a staggered configuration in which at least one outcoupler of the first set of outcouplers is positioned between two outcouplers of the second set of outcouplers.

The polarizer may include a half-wave plate.

The polarizer may be configured to selectively convert the display light to one of circularly s-polarized display light or circularly p-polarized display light.

In certain embodiments, a head-mounted display (HMD) may comprise a micro-display configured to project display light; an incoupling prism configured to receive the display light and transmit the display light into a waveguide at angles greater than a critical angle of the waveguide; and an outcoupler region of the waveguide comprising a first set of outcouplers and a second set of outcouplers, the first set of outcouplers configured to reflect only light within a first range of angles and the second set of outcouplers configured to reflect only light within a second range of angles that may be different from the first range of angles.

The first set and second set of outcouplers may include one or more angular bandwidth holograms.

At least one of the one or more angular bandwidth holograms may be an achromatic hologram.

The waveguide may include an eye-facing surface, such that the first set of outcouplers may be disposed at a first angle with the eye-facing surface, and such that the second set of outcouplers may be disposed at a second angle with the eye-facing surface.

Each outcoupler of the first set of outcouplers may be arranged as a contiguous series in a first portion of the outcoupler region of the waveguide.

The outcouplers of the first set of outcouplers and the outcouplers of the second set of outcouplers may be arranged in a staggered configuration in which at least one outcoupler of the first set of outcouplers is positioned between two outcouplers of the second set of outcouplers.

In certain embodiments, a method of expanding a field of view (FOV) of a wearable display device may comprise converting display light emitted from a micro-display of the wearable display device to polarized light having a first polarization or a second polarization; transmitting the polarized light into a waveguide of the wearable display device; reflecting a portion of the polarized light out of the waveguide by at least one outcoupler of a first subset of a plurality of outcouplers, the first subset of outcouplers being configured to reflect light having the first polarization; and reflecting a remaining portion of the polarized light out of the waveguide by at least one outcoupler of a second subset of the plurality of outcouplers, the second subset of outcouplers being configured to reflect light having the second polarization.

The first subset and second subset of outcouplers may include one or more holographic mirrors.

At least one of the holographic mirrors may be an achromatic hologram.

The waveguide may include an eye-facing surface, such that the method may include disposing each outcoupler of the first subset of outcouplers at a first angle with the eye-facing surface, and such that the method further may include disposing each outcoupler of the second subset of outcouplers at a second angle with the eye-facing surface.

The method may further comprise arranging each outcoupler of the first subset of outcouplers as a contiguous series within the waveguide.

The method may further comprise arranging the outcouplers of the first subset of outcouplers and the outcouplers of the second subset of outcouplers in a staggered configuration such that at least one outcoupler of the first subset of outcouplers is disposed between two outcouplers of the second subset of outcouplers within the waveguide.

Transmitting the polarized light into a waveguide of the wearable display device may include transmitting the polarized light via an incoupling prism configured to direct the polarized light towards the plurality of outcouplers within the waveguide.

Converting the display light emitted from the micro-display to the polarized light having the first polarization or the second polarization may include converting linearly polarized display light emitted from the micro-display to circularly polarized display light having the first polarization or the second polarization.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items. It will be appreciated that unless specifically indicated, aspects of the accompanying drawings are not presented to scale and are not to be assumed to be so presented.

FIG. 1 illustrates an example wearable display device in accordance with various embodiments.

FIG. 2 illustrates a diagram of a wearable display device in accordance with some embodiments.

FIG. 3 illustrates a partial component view of an HMD device having multiple polarization-based holographic outcouplers in accordance with some embodiments.

FIG. 4 illustrates a partial component view of an HMD device having multiple holographic outcouplers, each with a respective set of angular bandwidth mirrors arranged in a staggered configuration in accordance with some embodiments.

### DETAILED DESCRIPTION

Wearable display devices for presenting AR content typically employ an optical combiner light guide (also referred to herein as a “refractive waveguide” or simply “waveguide”) to convey display light emitted by a display to a user's eye while also permitting light from the real-world scene to pass through the waveguide to the user's eye, resulting in the imagery represented by the display light overlaying the real-world scene from the perspective of the user. Typically, the waveguide relies on total internal reflection (TIR) to convey light received from the display via incoupling features at one end of the waveguide to outcoupling features facing the user's eye on the other end of the waveguide. The outcoupling features are configured to direct light beams from within the waveguide out of the waveguide such that the user perceives the projected light beams as images displayed in a field of view (FOV) area of a display component located in front of a user's eye, such as a lens of an HMD device having the general shape and size of eyeglasses. The light beams exiting from the waveguide then overlap at an eye relief distance from the waveguide, forming a “pupil” within which a virtual image generated by the image source can be viewed.

A relatively large FOV area and pupil are desirable in an HMD device to provide an in-focus, immersive experience to the user. It is also desirable that an HMD device be able to fit a variety of users despite differences in a relative size and position of those users' respective facial features in relation to components of the HMD. For example, one design consideration for an HMD device that can be worn by a wide range of users is the “eyebox”, or a 3D volume in space within which the pupil of an eye must be positioned in order to satisfy a series of viewing experience criteria (such as the user being able to see all four edges of a virtual image). The larger the eyebox, the larger the range of users the HMD device can accommodate. Increasing the size of the eyebox of an HMD generally corresponds to an expansion of the FOV area and pupil of the HMD as well.

A number of design elements of an HMD device contribute to the size of the FOV area, pupil, and eyebox. For example, the configuration of the outcoupling features within the outcoupling region of a waveguide can be configured to provide an expanded FOV while also expanding the pupil and eyebox. In some HMD devices, the outcoupling features (or “outcouplers”) include partial mirror coatings that serve to direct the light from within the waveguide outward towards a user's eye. However, partial mirror outcouplers are challenging to mass produce, have low efficiency (e.g., ˜10% reflective efficiency), and may be visible within the lens of an HMD device (i.e., as stripes or lines visible to the user or an observer).

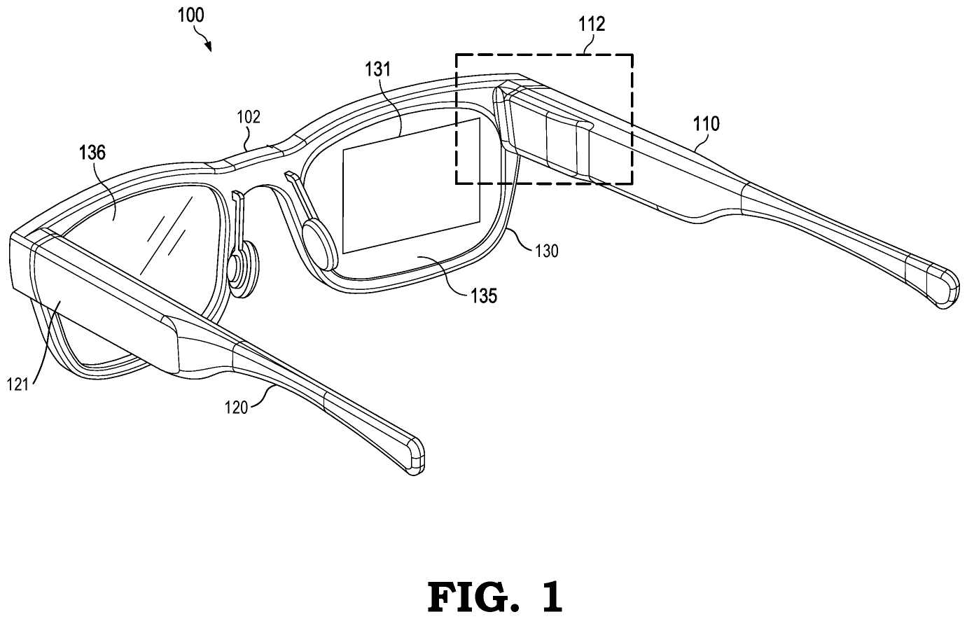

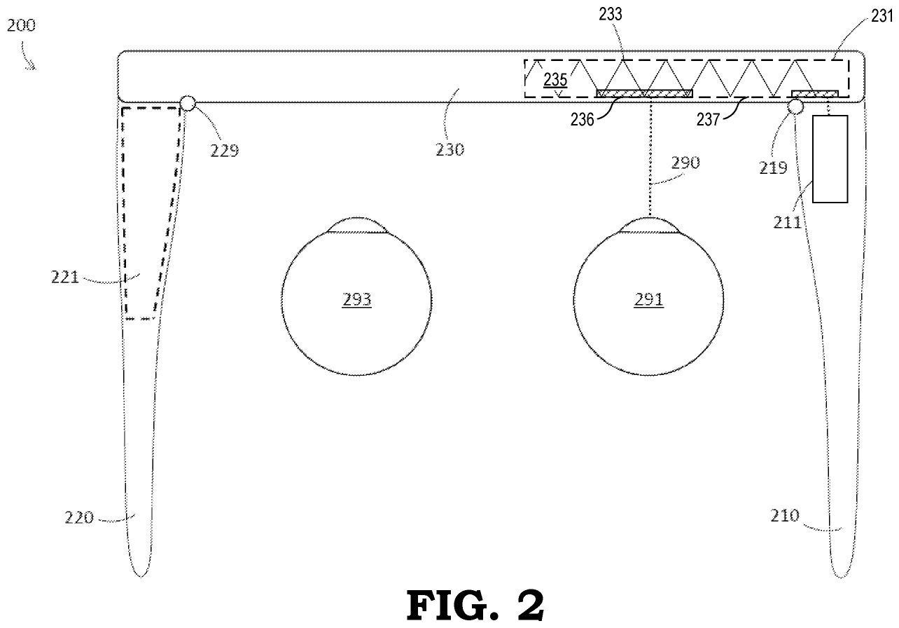

Alternatively, holographic optical elements (HOEs) can be used as outcouplers in some HMDs, as shown in FIGS. 1 and 2. While HOE outcouplers are generally easier to mass-produce and have greater efficiency (e.g., ˜58% reflective efficiency), they also typically utilize (and may require) a collimator optic. Additionally, there is a tradeoff between efficiency and angular wavelength bandwidth in HMDs employing HOE outcouplers.

Embodiments of systems, devices, and techniques described herein generally provide an increased size of an eyebox presented by an HMD device by utilizing multiple outcouplers, each including multiple holographic mirrors. In certain embodiments, such holographic mirrors are configured to pass one type of circularly polarized light while reflecting another. In such embodiments, linear light from a micro-display is polarized via a controllable polarizer that switches between s-type and p-type circular polarization, collimated (such as via a refractive collimator), passed to a TIR waveguide via an incoupling prism, and directed via the multiple outcouplers to an eye of a user. By configuring the multiple outcouplers to each have a different angle with an eye-facing surface of the waveguide, the resulting disparity allows FOV area expansion based on polarization of light from a single micro-display. Moreover, as each outcoupler includes multiple holographic mirrors, the resulting horizontal eyebox is expanded. Thus, embodiments advantageously enable an expanded FOV area, pupil, and eyebox for an incorporating wearable display device. In certain embodiments, the holographic mirrors may include one or more angular bandwidth holograms, which are configured to reflect light incident on the hologram at a specific angle or a specific range of angles. As used herein, an angular bandwidth hologram indicates that when used in conjunction with multiple such holograms, the angular bandwidth respectively associated with each hologram either does not overlap that associated with other holograms, or has minimal overlap, such as to minimize crosstalk between multiple holographic mirrors.

FIG. 1 illustrates an example display system 100 having a support structure that includes an arm 110, which houses a laser projection system configured to project images toward the eye of a user, such that the user perceives the projected images as being displayed in a field of view (FOV) area 131 of a display at one or both of lens elements 135, 136. In the depicted embodiment, the display system 100 is a wearable head-mounted display (HMD) that includes a support structure 102 configured to be worn on the head of a user and has a general shape and appearance of an eyeglasses frame. As used herein, embodiments of wearable display devices include, and are referenced interchangeably with, both WHUD devices and HMD devices. The support structure 102 includes a first arm 110, a second arm 120, and a front frame 130, which is physically coupled to the first arm 110 and the second arm 120. When worn by a user, the first arm 110 may be positioned on a first side of a head of the user, while the second arm 120 may be positioned on a second side of the head of the user opposite to the first side of the head of the user, and the front frame 130 may be positioned on a front side of the head of the user. The support structure 102 contains or otherwise includes various components to facilitate the projection of such images toward the eye of the user, such as a light engine, laser projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the display system 100. In some embodiments, some or all of these components of the display system 100 are fully or partially contained within an inner volume of support structure 102, such as within the arm 110 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 135, 136 are used by the display system 100 to provide an augmented reality (AR) or mixed reality (MR) display in which rendered graphical content can be superimposed over or otherwise provided in conjunction with a real-world view as perceived by the user through the lens elements 135, 136. For example, laser light used to form a perceptible image or series of images may be projected by a laser projector of the display system 100 onto the eye of the user via a series of optical elements, such as a waveguide formed at least partially in the corresponding lens element, one or more scan mirrors, and one or more optical relays. One or both of the lens elements 135, 136 thus include at least a portion of a waveguide that routes display light received by one or more incouplers of the waveguide to one or more outcouplers of the waveguide, which output the display light toward an eye of a user of the display system 100. The display light is modulated and projected onto the eye of the user such that the user perceives the display light as an image. In addition, each of the lens elements 135, 136 is sufficiently transparent to allow a user to see through the lens elements to provide a field of view of the user's real-world environment such that the image appears superimposed over at least a portion of the real-world environment.

Non-limiting example display architectures could include scanning laser projector and holographic optical element combinations, side-illuminated optical light guide displays, pin-light displays, or any other wearable heads-up display technology as appropriate for a given application. The term light engine as used herein is not limited to referring to a singular light source, but can also refer to a plurality of light sources, and can also refer to a light engine assembly. A light engine assembly may include some components which enable the light engine to function, or which improve operation of the light engine. As one example, a light engine may include a light source, such as a laser or a plurality of lasers. The light engine assembly may additionally include electrical components, such as driver circuitry to power the at least one light source. The light engine assembly may additionally include optical components, such as collimation lenses, a beam combiner, or beam shaping optics. The light engine assembly may additionally include beam redirection optics, such as least one MEMS mirror, which can be operated to scan light from at least one laser light source, such as in a scanning laser projector. In the above example, the light engine assembly is housed within the region 112 and includes a light source and also components, which take the output from at least one light source and produce conditioned display light to convey AR content. All of the components in the light engine assembly may be included in a housing of the light engine assembly, affixed to a substrate of the light engine assembly, such as a printed circuit board or similar, or separately mounted components of a wearable heads-up display (WHUD).

In some embodiments, the projector is a matrix-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 131, of the display system 100. The scan area size corresponds to the size of the FOV area 131 and the scan area location corresponds to a region of one of the lens elements 135, 136 at which the FOV area 131 is visible to the user. Generally, it is desirable for a display to have a wide FOV area to accommodate the outcoupling of light across a wide range of angles. Herein, the range of different user eye positions that will be able to see the display is referred to as the eyebox of the display.

In some embodiments, the projector routes light via first and second scan mirrors, an optical relay disposed between the first and second scan mirrors, and a waveguide disposed at the output of the second scan mirror. In some embodiments, at least a portion of an outcoupler of the waveguide may overlap the FOV area 131.

FIG. 2 illustrates a diagram of a wearable display device 200 in accordance with some embodiments. In some embodiments, the wearable display device 200 may implement or be implemented by aspects of the wearable display device 100. For example, the wearable display device 200 may include a first arm 210, a second arm 220, and a front frame 230. The first arm 210 may be coupled to the front frame 230 by a hinge 219, which allows the first arm 210 to rotate relative to the front frame 230. The second arm 220 may be coupled to the front frame 230 by the hinge 229, which allows the second arm 220 to rotate relative to the front frame 230.

In the example of FIG. 2, the wearable display device 200 may be in an unfolded configuration, in which the first arm 210 and the second arm 220 are rotated such that the wearable display device 200 can be worn on a head of a user, with the first arm 210 positioned on a first side of the head of the user, the second arm 220 positioned on a second side of the head of the user opposite the first side, and the front frame 230 positioned on a front of the head of the user. The first arm 210 and the second arm 220 can be rotated towards the front frame 230, until both the first arm 210 and the second arm 220 are approximately parallel to the front frame 230, such that the wearable display device 200 may be in a compact shape that fits conveniently in a rectangular, cylindrical, or oblong case. Alternatively, the first arm 210 and the second arm 220 may be fixedly mounted to the front frame 230, such that the wearable display device 200 cannot be folded.

In FIG. 2, the first arm 210 carries a light engine 211. The second arm 220 carries a power source 221. The front frame 230 carries a diffractive waveguide 235 including an incoupling optical redirector (incoupler) 231, an outcoupling optical redirector (outcoupler) 233, and at least one set of electrically conductive current paths, which provide electrical coupling between the power source 221 and electrical components (such as the light engine 211) carried by the first arm 210. Such electrical coupling could be provided indirectly, such as through a power supply circuit, or could be provided directly from the power source 221 to each electrical component in the first arm 210. As used herein, the terms carry, carries or similar do not necessarily dictate that one component physically supports another component. For example, it is stated above that the first arm 210 carries the light engine 211. This could mean that the light engine 211 is mounted to or within the first arm 210, such that the first arm 210 physically supports the light engine 211. However, it could also describe a direct or indirect coupling relationship, even when the first arm 210 is not necessarily physically supporting the light engine 211.

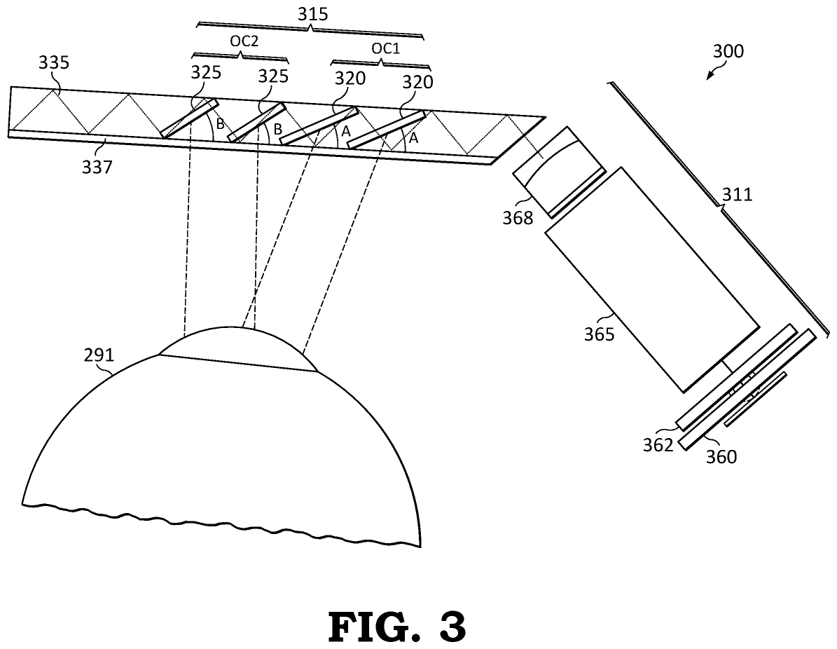

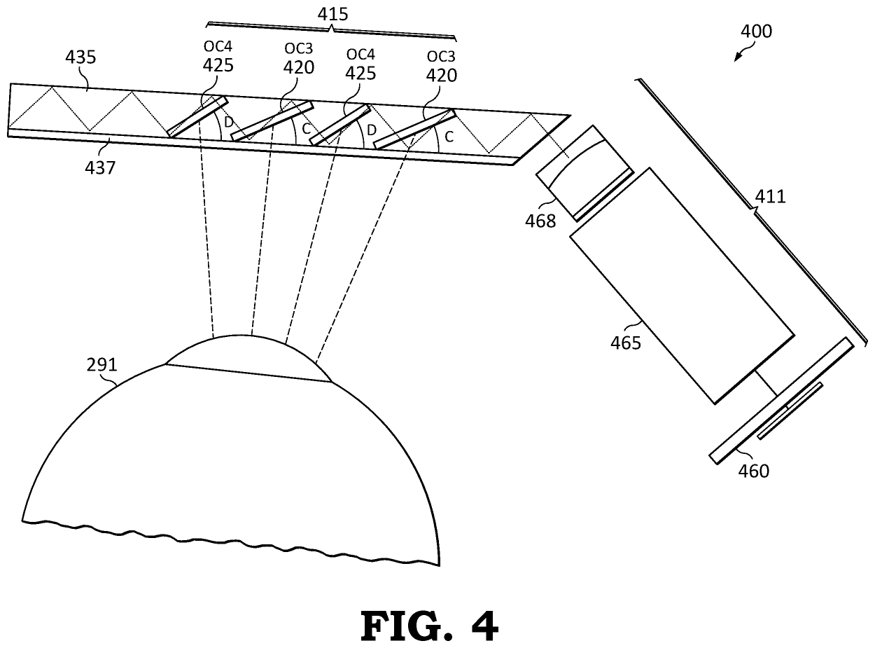

The light engine 211 can output a display light 290 (simplified for this example) representative of AR content or other display content to be viewed by a user. The display light 290 can be redirected by diffractive waveguide 235 towards an eye 291 of the user, such that the user can see the AR content. The display light 290 from the light engine 211 impinges on the incoupler 231 and is redirected to travel in a volume of the diffractive waveguide 235, where the display light 290 is guided through the light guide, such as by total internal reflection (TIR) and/or surface treatments such as holograms or reflective coatings. Subsequently, the display light 290 traveling in the volume of the diffractive waveguide 235 impinges on the outcoupler 233, which redirects the display light 290 out of the diffractive waveguide 235 and towards the eye 291 of a user. In the wearable display device 200, the depicted outcoupler 233 is an HOE outcoupler with an eye-facing surface 236 that is parallel to (and possibly coplanar with) an eye-facing surface 237 of the waveguide 235. Elsewhere herein, FIGS. 3 and 4 depict embodiments in which alternative outcouplers provide an expanded eyebox, pupil, and FOV area.

The wearable display device 200 may include a processor (not shown) that is communicatively coupled to each of the electrical components in the wearable display device 200, including but not limited to the light engine 211. The processor can be any suitable component which can execute instructions or logic, including but not limited to a micro-controller, microprocessor, multi-core processor, integrated-circuit, ASIC, FPGA, programmable logic device, or any appropriate combination of these components. The wearable display device 200 can include a non-transitory processor-readable storage medium, which may store processor readable instructions thereon, which when executed by the processor can cause the processor to execute any number of functions, including causing the light engine 211 to output the light 290 representative of display content to be viewed by a user, receiving user input, managing user interfaces, generating display content to be presented to a user, receiving and managing data from any sensors carried by the wearable display device 200, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components.

FIGS. 3 and 4 illustrate wearable display devices using specialized holographic outcouplers to expand the FOV area, eyebox, and pupil of the waveguide.

FIG. 3 illustrates a partial component view of an HMD device 300 having multiple polarization-based holographic outcouplers 320 (OC1) and 325 (OC2) in accordance with some embodiments. The HMD device 300 includes a light engine 311 with a micro-display 360 connected to one or more computing components (not shown) responsible for providing computer-generated AR content or other display content to the micro-display. In some embodiments, the computer-generated content includes video content, images, or text that is intended to be viewed by a user wearing the HMD.

In the depicted embodiment, linearly polarized light is emitted from the micro-display 360 and passes through a controllable polarizer 362, such as a half-wave plate (HWD). The controllable polarizer 362 is configured to convert the light from having linear polarization to circular polarization by, as one non-limiting example, rapidly switching between states that are each associated with a voltage-controlled phase difference between orthogonal axes to selectively produce either s-polarized or p-polarized light. The circularly polarized light is then collimated via collimator 365 (e.g., a refractive collimator) and directed into the waveguide 335 via an incoupling prism 368. The waveguide 335 facilitates total internal reflection (TIR) of the light such that it is conveyed along the waveguide to an outcoupler region 315. In the depicted embodiment, the outcoupler region 315 includes two sets of outcouplers 320 (OC1) and 325 (OC2), each of which includes multiple holographic mirrors. In some embodiments, the holographic mirrors may comprise angular bandwidth holograms, such as in order to avoid crosstalk in consecutively positioned holographic mirrors. In addition, in certain embodiments, the holographic mirrors may comprise achromatic holograms, such as to minimize diffraction grating effects and maintain content image quality.

Although the outcoupler region 315 of the depicted embodiment is shown as encompassing two sets of outcouplers, and each set of outcouplers is shown having two holographic mirrors, any quantity of sets of outcouplers having any quantity of holographic mirrors may be included in the outcoupler region 315 of the waveguide 335.

Each of the holographic mirrors respectively associated with outcouplers 320 and 325 (OC1 and OC2) is configured to reflect light of a specific polarization and to transmit light of the opposite polarization. For example, in some embodiments, the holographic mirrors of OC1 are s-polarized and the holographic mirrors of OC2 are p-polarized. That is, the OC1 holographic mirrors reflect light having p-polarization and transmit light having s-polarization and the holographic mirrors of OC2 reflect light having s-polarization and transmit light having p-polarization. This allows different portions of the light traveling within the waveguide to be transmitted through certain of the holographic mirrors based on their polarization with minimal interference in order to be outcoupled by another of the holographic mirrors configured to reflect the polarization of the particular portion of light.

Each of the holographic mirrors in each set of outcouplers 320 and 325 is also disposed at a specific angle with respect to an eye-facing surface 337 of the waveguide 335 that is different from a corresponding angle at which the holographic mirrors of the other set of outcouplers are disposed, such as in order to reflect light of specific polarizations out of the waveguide at varying angles and thereby provide an expanded FOV area. For example, in the depicted embodiment the OC1 holographic mirrors of outcoupler 320 are oriented to have a first angle (A) relative to eye-facing surface 337, and the OC2 holographic mirrors of outcoupler 325 are oriented to have a second angle (B) that is offset by approximately 15° from the first angle (A). Generally, an offset of 10° between the respective angles associated with each outcoupler prevents interference between the light reflected from each set of the respectively associated holographic mirrors, such as in order to minimize visual artifacts while expanding the pupil of the HMD.

In the depicted embodiment of FIG. 3, the holographic mirrors in each outcoupler 320 and 325 are shown as contiguous sets (i.e., OC1, OC1, OC2, OC2). However, depending on pupil expansion goals, in various embodiments the sets of holographic mirrors respectively associated with each of the multiple outcouplers may be positioned in a variety of different arrangements.

As one example of an embodiment with a non-contiguous arrangement of outcoupler-associated holographic mirrors, FIG. 4 illustrates a partial component view of an HMD device 400 having multiple holographic outcouplers 420 (OC3) and 425 (OC4), each with a respective set of angular bandwidth holograms collectively arranged in a staggered configuration (i.e., OC3, OC4, OC3, OC4).

In a manner similar to that described with respect to corresponding components of HMD device 300, light from the micro-display 360 is then collimated via collimator 365, directed into a waveguide 435 via the incoupling prism 368, and conveyed along the waveguide to an outcoupler region 415. Notably, because angular bandwidth holograms are used as the holographic mirrors associated with each of the two outcouplers 420 and 425, the expanded eyebox and FOV area may be provided without a controllable polarizer, such as controllable polarizer 362 of FIG. 3.

In the depicted embodiment, the outcoupler region 415 includes two outcouplers 420 (OC3) and 425 (OC4), each of which includes a set of multiple angular bandwidth holograms used as holographic mirrors.

As noted elsewhere herein, angular bandwidth holograms such as those associated with the outcouplers OC3 and OC4 of the HMD device 400 are configured to reflect light incident on the hologram at a specific angle or a specific range of angles. That is, each of the angular bandwidth holograms in OC3 is disposed at an angle (C) with respect to an eye-facing surface 437 of waveguide 435 in order to reflect light traveling within the waveguide at a first range of angles, while transmitting the light traveling at angles outside of the first range of angles. Likewise, the angular bandwidth holograms in OC4 are disposed at an angle (D) with respect to the eye-facing surface 437 of waveguide 435 to reflect light traveling within the waveguide at a second range of angles, different from the first range of angles, while transmitting the light traveling at angles outside of the second range of angles. This allows different portions of the light to be reflected out of the waveguide from different locations and at different angles, which results in an expanded field of view and pupil expansion to enhance user experience and allow for use of the HMD device by a range of users without selectively controlling a circular polarization of the waveguided light.

For ease of description, HMD device 300 utilizes contiguous positioning of outcoupler-specific polarization-based holographic mirrors with a controllable polarizer. Similarly, for ease of description HMD device 400 utilizes a staggered positioning of outcoupler-specific angular bandwidth holograms. However, it will be appreciated that in various embodiments, such features may be configured differently and in various combinations. For example, in certain embodiments sets of polarization-based holographic mirrors may be used in a staggered configuration, sets of non-polarization-based angular bandwidth holograms may be used in a contiguous configuration, etc.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A wearable display device, comprising:
a micro-display configured to project display light;
a polarizer configured to receive the display light and selectively convert the display light to one of s-polarized display light or p-polarized display light;
an incoupling prism configured to receive the polarized display light and transmit the polarized display light into a waveguide; and
an outcoupler region of the waveguide comprising a first set of outcouplers and a second set of outcouplers, the first set of outcouplers configured to reflect s-polarized light and the second set of outcouplers configured to reflect p-polarized light.

2. The wearable display device of claim 1, wherein the first set and second set of outcouplers comprise one or more holographic mirrors.

3. The wearable display device of claim 2, wherein at least one of the holographic mirrors is an achromatic hologram.

4. The wearable display device of claim 1, wherein the waveguide comprises an eye-facing surface, wherein each outcoupler of the first set of outcouplers is disposed at a first angle with the eye-facing surface, and wherein each outcoupler of the second set of outcouplers is disposed at a second angle with the eye-facing surface.

5. The wearable display device of claim 1, wherein each outcoupler of the first set of outcouplers is positioned adjacent to another outcoupler of the first set of outcouplers.

6. The wearable display device of claim 1, wherein the outcouplers of the first set of outcouplers and the outcouplers of the second set of outcouplers are arranged in a staggered configuration in which at least one outcoupler of the first set of outcouplers is positioned between two outcouplers of the second set of outcouplers.

7. The wearable display device of claim 1, wherein the polarizer comprises a half-wave plate.

8. The wearable display device of claim 1, wherein the polarizer is configured to selectively convert the display light to one of circularly s-polarized display light or circularly p-polarized display light.

9. A head-mounted display (HMD), comprising:
a micro-display configured to project display light;
an incoupling prism configured to receive the display light and transmit the display light into a waveguide at angles greater than a critical angle of the waveguide; and
an outcoupler region of the waveguide comprising a first set of outcouplers and a second set of outcouplers, the first set of outcouplers configured to reflect only light within a first range of angles and the second set of outcouplers configured to reflect only light within a second range of angles that is different from the first range of angles.

10. The HMD of claim 9, wherein the first set and second set of outcouplers comprise one or more angular bandwidth holograms.

11. The HMD of claim 10, wherein at least one of the one or more angular bandwidth holograms is an achromatic hologram.

12. The HMD of claim 9, wherein the waveguide comprises an eye-facing surface, wherein the first set of outcouplers is disposed at a first angle with the eye-facing surface, and wherein the second set of outcouplers is disposed at a second angle with the eye-facing surface.

13. The HMD of claim 9, wherein each outcoupler of the first set of outcouplers is positioned adjacent to another outcoupler of the first set of outcouplers in a first portion of the outcoupler region of the waveguide.

14. The HMD of claim 9, wherein the outcouplers of the first set of outcouplers and the outcouplers of the second set of outcouplers are arranged in a staggered configuration in which at least one outcoupler of the first set of outcouplers is positioned between two outcouplers of the second set of outcouplers.

15. A method of expanding a field of view (FOV) of a wearable display device, comprising:
converting display light emitted from a micro-display of the wearable display device to polarized light having a first polarization or a second polarization;
transmitting the polarized light into a waveguide of the wearable display device;
directing a portion of the polarized light out of the waveguide by at least one outcoupler of a first subset of a plurality of outcouplers, the first subset of outcouplers being configured to reflect light having the first polarization; and
directing a remaining portion of the polarized light out of the waveguide by at least one outcoupler of a second subset of the plurality of outcouplers, the second subset of outcouplers being configured to reflect light having the second polarization.

16. The method of claim 15, wherein the first subset and second subset of outcouplers comprise one or more holographic mirrors.

17. The method of claim 16, wherein at least one of the holographic mirrors is an achromatic hologram.

18. The method of claim 15, wherein the waveguide comprises an eye-facing surface, wherein the method comprises disposing each outcoupler of the first subset of outcouplers at a first angle with the eye-facing surface, and wherein the method further comprises disposing each outcoupler of the second subset of outcouplers at a second angle with the eye-facing surface.

19. The method of claim 15, further comprising positioning each outcoupler of the first subset of outcouplers adjacent to another outcoupler of the first set of outcouplers within the waveguide.

20. The method of claim 15, further comprising arranging the outcouplers of the first subset of outcouplers and the outcouplers of the second subset of outcouplers in a staggered configuration in which at least one outcoupler of the first subset of outcouplers is disposed between two outcouplers of the second subset of outcouplers within the waveguide.

21. The method of claim 15, wherein transmitting the polarized light into a waveguide of the wearable display device includes transmitting the polarized light via an incoupling prism configured to direct the polarized light towards the plurality of outcouplers within the waveguide.

22. The method of claim 15, wherein converting the display light emitted from the micro-display to the polarized light having the first polarization or the second polarization includes converting linearly polarized display light emitted from the micro-display to circularly polarized display light having the first polarization or the second polarization.
